(19) United States
(12) Patent Application Publication
(10) Pub. No.: US 2012/0174900 A1
(43) Pub. Date: Jul. 12, 2012

(54) APPARATUS AND METHOD FOR DETECTING VARIATION ABNORMALITY IN AIR-FUEL RATIO BETWEEN CYLINDERS

(75) Inventors: Hiroshi Miyamoto, Susono-shi (JP); Yasushi Iwazaki, Ebina-shi (JP); Hiroshi Sawada, Gotenba-shi (JP)

(73) Assignee: TOYOTA JIDOSHA KABUSHIKI KAISHA, Toyota-shi (JP)

(21) Appl. No.: 13/375,048

(22) PCT Filed: Dec. 24, 2010
(86) PCT No.: PCT/JP2010/007531

§ 371 Date: Nov. 29, 2011

(51) Int. Cl. F02D 41/14; F01N 11/00

(52) U.S. Cl. 123/703; 123/672

(57) ABSTRACT

According to a first aspect of the present invention, there is provided an apparatus for detecting variation abnormality in an air-fuel ratio between cylinders comprising a wide-range air-fuel ratio sensor and an O₂ sensor provided in an exhaust passage upstream of an exhaust gas purifying apparatus arranged in the exhaust passage for an internal combustion engine having a plurality of cylinders, air-fuel ratio controlling unit for performing air-fuel ratio control for a predetermined period in such a manner as to make an exhaust air-fuel ratio be equal to a stoichiometric air-fuel ratio based upon output from the wide-range air-fuel ratio sensor, and abnormality detecting unit for detecting variation abnormality in an air-fuel ratio between cylinders based upon output from the O₂ sensor for the predetermined period when the air-fuel ratio control is performed.

### TECHNICAL FIELD

The present invention relates to an apparatus and a method for detecting variation abnormality in an air-fuel ratio between cylinders, which are applied to an internal combustion engine having a plurality of cylinders.

### BACKGROUND ART

In an internal combustion engine equipped with an exhaust gas purifying apparatus using a catalyst, in order that harmful components in an exhaust gas are generally purified by the catalyst in a highly efficient manner, it is fundamental to control a mixing ratio of air and fuel in a mixture burned in the internal combustion engine, that is, an air-fuel ratio. For controlling such an air-fuel ratio, an air-fuel ratio sensor is provided in an exhaust passage in the internal combustion engine, and feedback control is performed in such a manner as to make the air-fuel ratio detected by the air-fuel ratio sensor be equal to a predetermined target air-fuel ratio.

On the other hand, in an internal combustion engine having a plurality of cylinders, that is, a multi-cylinder type internal combustion engine, since air-fuel ratio control is usually performed using the same control amount to all the cylinders, there are some cases where an actual air-fuel ratio varies between cylinders even if the air-fuel ratio control is performed. When a degree of the variation is small at this time, since the variation can be absorbed by air-fuel ratio feedback control and the harmful components in the exhaust gas can be purified also in the catalyst, it has no adverse influence on exhaust emissions and raises no particular problem. However, when the air-fuel ratio varies largely between the cylinders due to a failure of a fuel injection system in a part of the cylinders, the exhaust gas emission is deteriorated, thus raising the problem. It is desired to detect a variation in the air-fuel ratio as large as to thus deteriorate the exhaust emission, as abnormality. Particularly in a case of an internal combustion engine for an automobile, for beforehand preventing a travel of a vehicle in which the exhaust emission has deteriorated, it is requested to detect the variation abnormality in the air-fuel ratio between the cylinders (on board), and there is recently the movement of legalizing such detection of the variation abnormality.

Patent Literature 1 discloses a system enabling variation abnormality in an air-fuel ratio between cylinders to be detected. In this system, primary air-fuel ratio control based upon output by a wide-range air-fuel ratio sensor arranged upstream of a catalyst for exhaust gas purification and assistant air-fuel ratio control based upon output from an O₂ sensor arranged downstream of the catalyst are performed as air-fuel ratio control. In addition, using the characteristic that as the variation in the air-fuel ratio between the cylinders becomes the larger, a control amount in the assistant air-fuel ratio control shows the more peculiar inclination, a parameter in regard to the variation in the air-fuel ratio between the cylinders is found based upon the control amount.

### CITATION LIST

### Patent Literature

PTL 1: Japanese Patent Laid-Open No. 2009-209747

### SUMMARY OF INVENTION

Incidentally there are some engines among internal combustion engines, such as a V-type engine in which explosion strokes are sequentially repeated by irregular intervals. There are some cases where a staying time of a gas in the vicinity of a sensor is inequable in such an internal combustion engine. Therefore, in a case where there occurs variation abnormality in an air-fuel ratio between cylinders in such an engine, it is generally not easy to appropriately detect the variation abnormality in the air-fuel ratio between the cylinders.

Therefore, an object of the present invention is to, in a case where there occurs variation abnormality in an air-fuel ratio between the cylinders even if an internal combustion engine having a plurality of cylinders is an engine in which explosion strokes are sequentially repeated by irregular intervals, appropriately detect the variation abnormality in the air-fuel ratio between the cylinders.

The present invention provides a practical and highly accurate apparatus and method for detecting variation abnormality in an air-fuel ratio between cylinders.

According to a first aspect of the present invention, there is provided an apparatus for detecting variation abnormality in an air-fuel ratio between cylinders. The apparatus comprises first air-fuel ratio detecting means provided in an exhaust passage upstream of an exhaust gas purifying apparatus arranged in the exhaust passage for an internal combustion engine having a plurality of cylinders, second air-fuel ratio detecting means provided in the exhaust passage upstream of the exhaust gas purifying apparatus and having an output characteristic that an output variation to an air-fuel ratio change in a predetermined air-fuel ratio region is larger as compared to an output characteristic of the first air-fuel ratio detecting means, air-fuel ratio controlling means for performing air-fuel ratio control for a predetermined period in such a manner as to make an exhaust air-fuel ratio be equal to an air-fuel ratio in the predetermined air-fuel ratio region based upon output from the first air-fuel ratio detecting means, and abnormality detecting means for detecting variation abnormality in an air-fuel ratio between cylinders based upon output from the second air-fuel ratio detecting means for the predetermined period when the air-fuel ratio control is performed by the air-fuel ratio controlling means.

The first air-fuel ratio detecting means may be constructed of a wide-range air-fuel ratio sensor, and the second air-fuel ratio detecting means may be constructed of an O₂ sensor.

The predetermined period may include a period for which one cycle is sequentially generated in all of the plurality of the cylinders.

The air-fuel ratio controlling means may perform the air-fuel ratio control for the predetermined period in such a manner as to make the exhaust air-fuel ratio be equal to a theoretical air-fuel ratio within the predetermined air-fuel ratio region based upon the output from the first air-fuel ratio detecting means.

The abnormality detecting means may include value calculating means for calculating a value reflecting a change of the output from the second air-fuel ratio detecting means for the predetermined period based upon the output, and determining means for determining that there occurs the variation abnormality in the air-fuel ratio between the cylinders when the value calculated by the value calculating means exceeds a predetermined value.

The air-fuel ratio controlling means may perform the air-fuel ratio control in such a manner as to make the exhaust air-fuel ratio be equal to the air-fuel ratio within the predetermined air-fuel ratio region set based upon at least one of a range of an allowance error of an injection quantity by an injector and detection accuracy in the variation abnormality in the air-fuel ratio between the cylinders.

The air-fuel ratio controlling means may repeatedly perform the air-fuel ratio control for the predetermined period in such a manner as to make the exhaust air-fuel ratio be equal to each of a plurality of air-fuel ratios within the predetermined air-fuel ratio region, based upon the output from the first air-fuel ratio detecting means, and the abnormality detecting means may include value calculating means for calculating a value reflecting a change of the output from the second air-fuel ratio detecting means for the predetermined period based upon the output from the second air-fuel ratio detecting means for the predetermined period to each of the plurality of the air-fuel ratios when the air-fuel ratio control is performed by the air-fuel ratio controlling means, maximum value selecting means for selecting a maximum value from the plurality of the values calculated from the value calculating means, and determining means for determining that there occurs the variation between the cylinders when the value selected by the maximum value selecting means exceeds a predetermined value.

There may be further provided inhibiting means for inhibiting an operation of the determining means when a deviation amount from a reference air-fuel ratio in regard to an air-fuel ratio set as a target in the air-fuel ratio controlling means corresponding to the value selected by the maximum value selecting means exceeds a predetermined deviation amount.

The apparatus for detecting the variation abnormality in the air-fuel ratio between the cylinders according to the present invention may further comprise heating means provided in the second air-fuel ratio detecting means, prerequisite determining means for determining whether or not prerequisites of the operations for the air-fuel ratio controlling means and the abnormality detecting means, which include an active condition that a state of the second air-fuel ratio detecting means is an active state, are satisfied, and heating controlling means for operating the heating means when it is determined by the prerequisite determining means that the prerequisite is not satisfied since only the active condition among the prerequisites is not established.

According to a second aspect of the present invention, there is provided a method for detecting variation abnormality in an air-fuel ratio between cylinders in an internal combustion engine having a plurality of cylinders. The method comprises a step for performing air-fuel ratio control for a predetermined period in such a manner as to make an exhaust air-fuel ratio be equal to an air-fuel ratio in a predetermined air-fuel ratio region based upon output from first air-fuel ratio detecting means provided in an exhaust passage upstream of an exhaust gas purifying apparatus, and a step for detecting variation abnormality in an air-fuel ratio between cylinders based upon output from second air-fuel ratio detecting means for the predetermined period when the air-fuel ratio control is performed, the second air-fuel ratio detecting means being provided in the exhaust passage upstream of the exhaust gas purifying apparatus and having an output characteristic that an output variation to an air-fuel ratio change in the predetermined air-fuel ratio region is larger as compared to an output characteristic of the first air-fuel ratio detecting means.

The step for detecting the abnormality preferably comprises a step for calculating a value reflecting a change of the output from the second air-fuel ratio detecting means for the predetermined period based upon the output, and a step for determining that there occurs the variation abnormality in the air-fuel ratio between the cylinders when the value calculated by the step for calculating the value exceeds a predetermined value.

The features and the advantages of the present invention described above and further features and advantages thereof will be apparent from an explanation of the following illustrative embodiments with reference to the accompanying drawings. Identical components or components corresponding to each other are referred to as identical codes.

### BRIEF DESCRIPTION OF DRAWINGS

FIG. 1 is a schematic diagram of an internal combustion engine according to a first embodiment in the present invention;

FIG. 2 is a graph showing output characteristics of a wide-range air-fuel ratio sensor provided in the internal combustion engine in FIG. 1;

FIG. 3 is a graph showing output characteristics of an O₂ sensor provided in the internal combustion engine in FIG. 1;

FIG. 4 is a schematic enlarged diagram of a part of the internal combustion engine in FIG. 1;

FIG. 5 is a flow chart according to the first embodiment;

FIG. 6 is experiment data, and data in a case of performing air-fuel ratio control in such a manner as to make an exhaust air-fuel ratio be equal to a stoichiometric air-fuel ratio, that is, a theoretical air-fuel ratio in regard to the internal combustion engine when there occurs no variation abnormality in an air-fuel ratio between cylinders;

FIG. 7A is experiment data in regard to the internal combustion engine when there occurs the variation abnormality in the air-fuel ratio between the cylinders, and data in a case of performing air-fuel ratio control in such a manner as to make the exhaust air-fuel ratio be equal to the stoichiometric air-fuel ratio;

FIG. 7B is experiment data in regard to the internal combustion engine when there occurs the variation abnormality in the air-fuel ratio between the cylinders, and data in a case of performing the air-fuel ratio control in such a manner as to make the exhaust air-fuel ratio be equal to a lean air-fuel ratio;

FIG. 8A is experiment data in regard to the internal combustion engine when there occurs the variation abnormality in the air-fuel ratio between the cylinders, and data in a case of performing the air-fuel ratio control in such a manner as to make the exhaust air-fuel ratio be equal to the stoichiometric air-fuel ratio;

FIG. 8B is experiment data in regard to the internal combustion engine when there occurs the variation abnormality in the air-fuel ratio between the cylinders, and data in a case of performing the air-fuel ratio control in such a manner as to make the exhaust air-fuel ratio be equal to a rich air-fuel ratio;

FIG. 9 is a flow chart according to a second embodiment;

FIG. 10 is a flow chart according to a third embodiment;

FIG. 11 is a flow chart according to a fourth embodiment; and

FIG. 12 is a flow chart according to a fifth embodiment.

### DESCRIPTION OF EMBODIMENTS

Hereinafter, embodiments in the present invention will be explained with reference to the accompanying drawings.

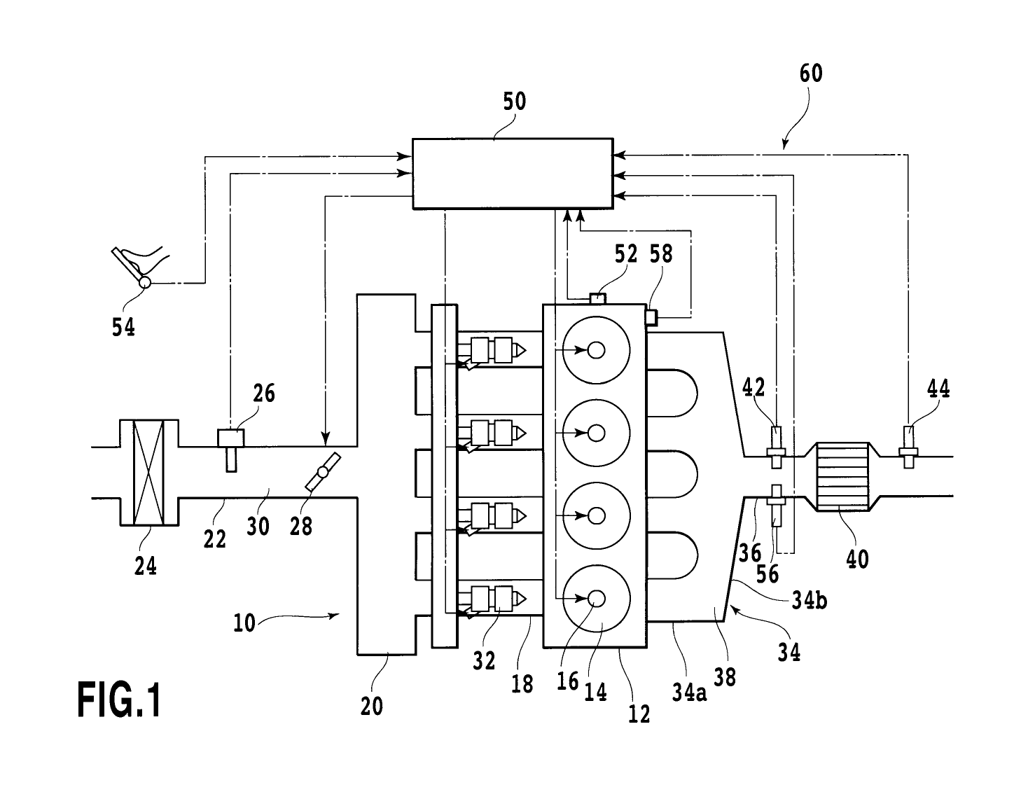

FIG. 1 is a schematic diagram of an internal combustion engine 10 according to a first embodiment in the present invention. As shown in the figure, the internal combustion engine (hereinafter, called engine simply) 10 burns a mixture of fuel and air within each of combustion chambers 14 formed in a cylinder block 12 and reciprocates a piston in the combustion chamber 14, thus generating power. The engine 10 is an engine with one cycle composed of four strokes. The engine 10 in the present embodiment is a multi-cylinder internal combustion engine for an automobile, and more specially a spark ignition type internal combustion engine with a parallel four-cylinder, that is, a gasoline engine. However, the internal combustion engine to which the present invention is applicable is not limited thereto, and, as long as the engine is a multi-cylinder internal combustion engine, there is no particular limit to the number of cylinders, the type of internal combustion engine, and the like.

Though not shown, an intake valve for opening/closing an intake port and an exhaust valve for opening/closing an exhaust port are arranged for each cylinder in the cylinder head of the engine 10. Each intake valve and each exhaust valve are opened/closed by a cam shaft. A spark plug 16 for igniting a mixture in the combustion chamber 14 is mounted in a crown portion of the cylinder head for each cylinder.

The intake port of each cylinder is connected to a surge tank 20 as an intake collector through a branch pipe 18 for each cylinder. An intake pipe 22 is connected to an upstream side of the surge tank 20, and an air cleaner 24 is mounted to an upstream end of the intake pipe 22. An air flow meter 26 for detecting an intake air quantity and an electronically controlled type throttle valve 28 are incorporated in the intake pipe 22 in order from the upstream side. An intake passage 30 is substantially formed by the intake port, the branch pipes 18, the surge tank 20, and the intake pipe 22.

An injector 32 for injecting fuel into the intake passage, particularly into the intake port is arranged for each cylinder. The fuel injected from the injector 32 is mixed with intake air to form a mixture, which is aspired into the combustion chamber 14 at an opening time of the intake valve, is compressed by the piston, and is ignited by the spark plug 16 for combustion.

Meanwhile, the exhaust port of each cylinder is connected to an exhaust manifold 34. The exhaust manifold 34 is composed of branch pipes 34a for each cylinder as the upstream portion and an exhaust collector 34b as the downstream portion. An exhaust pipe 36 is connected to a downstream side of the exhaust collector 34b. An exhaust passage 38 is substantially formed by the exhaust ports, the exhaust manifold 34, and the exhaust pipe 36. A catalyst member 40 including a three-way catalyst is mounted to the exhaust pipe 36. The catalyst member 40 corresponds to an exhaust gas purifying apparatus in the present invention. It should be noted that the catalyst member 40 acts to simultaneously purify NOx, HC, and CO as harmful components in an exhaust gas when an air-fuel ratio A/F of an exhaust gas flowing therein (exhaust air-fuel ratio) is in the vicinity of a theoretical air-fuel ratio (stoichiometric air-fuel ratio, for example, A/F=14.6).

A first air-fuel ratio sensor and a second air-fuel ratio sensor, that is, a pre-catalyst sensor 42 and a post-catalyst sensor 44 are disposed respectively at the upstream side and the downstream side of the catalyst member 40 for detecting exhaust air-fuel ratios. The pre-catalyst sensor 42 and the post-catalyst sensor 44 are located in the exhaust passage positioned immediately before and after the catalyst member 40 and output signals based upon oxygen concentrations in the exhaust gas.

The spark plugs 16, the throttle valve 28 and the injectors 32 described above, and the like are connected electrically to an electronically controlled unit (hereinafter, called ECU) 50 having a function as control means. The ECU 50 includes a CPU, a ROM, a RAM, an input/output port, and a memory device, which all are not shown, and the like. In addition, as shown in the figure, the air flow meter 26, the pre-catalyst sensor 42 and the post-catalyst sensor 44 described above, and further, a crank angle sensor 52 for detecting a crank angle of the internal combustion engine 10, an accelerator opening sensor 54 for detecting an accelerator opening, a third air-fuel ratio sensor 56, a water temperature sensor 58 for detecting an engine cooling water temperature, and other various sensors are connected electrically to the ECU 50 through an A/D converter which is not shown and the like. The ECU 50 controls the spark plug 16, the throttle valve 28, the injector 32 and the like based upon output and/or detection values from the various types of sensors for obtaining desired output to control an ignition timing, a fuel injection quantity, a fuel injection timing, a throttle opening and the like. It should be noted that the throttle opening is usually controlled to an opening corresponding to the accelerator opening.

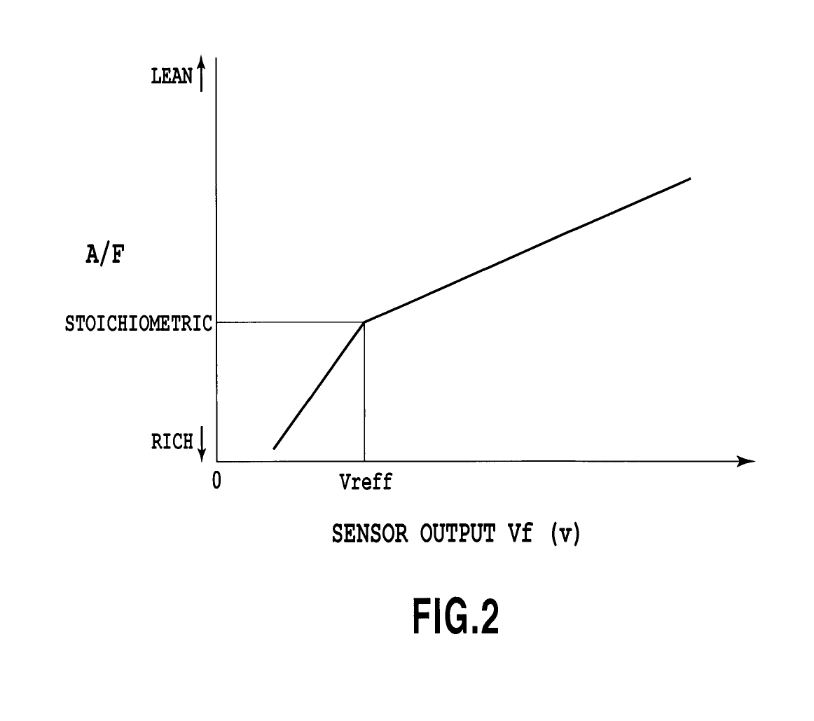

The pre-catalyst sensor 42 is constructed of a so-called wide-range air-fuel ratio sensor, and can sequentially detect air-fuel ratios over a relatively wide range. FIG. 2 shows output characteristics of the pre-catalyst sensor 42. As shown in the figure, the pre-catalyst sensor 42 outputs a voltage signal Vf of a magnitude in proportion to the detected exhaust air-fuel ratio. The output voltage when the exhaust air-fuel ratio is a stoichiometric air-fuel ratio is Vreff (for example, about 3.3V), and an inclination of an air-fuel ratio to a voltage characteristic changes across the stoichiometric air-fuel ratio.

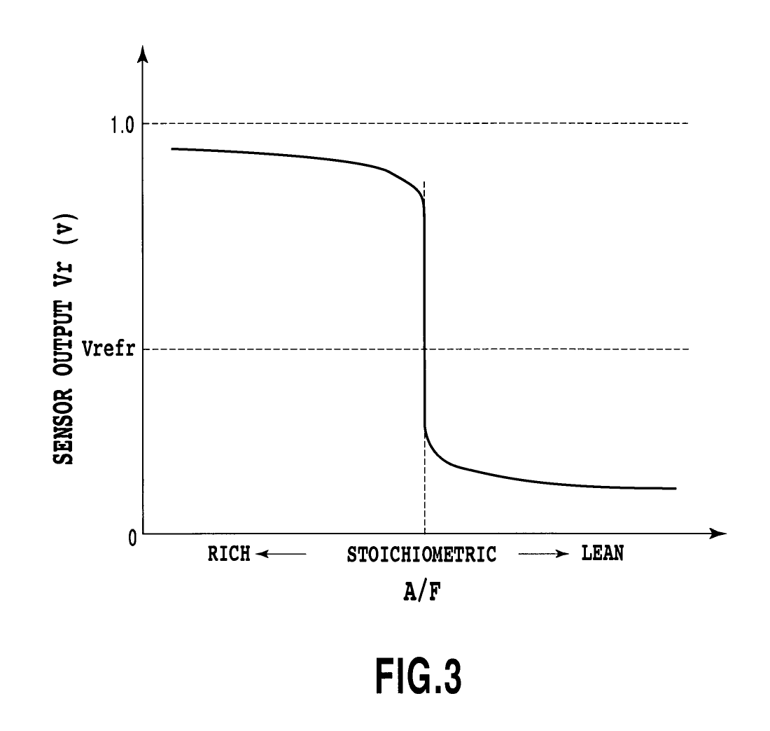

On the other hand, the post-catalyst sensor 44 is constructed of a so-called oxygen sensor or an O₂ sensor, and has the characteristic that an output value rapidly changes across the stoichiometric air-fuel ratio. FIG. 3 shows output characteristics of the post-catalyst sensor 44. As shown in the figure, an output voltage Vr of the post-catalyst sensor 44 transiently changes across the stoichiometric air-fuel ratio, and shows a low voltage of the order of 0.1V when the detected exhaust air-fuel ratio is leaner than the stoichiometric air-fuel ratio and a high voltage of the order of 0.9V when the detected exhaust air-fuel ratio is richer than the stoichiometric air-fuel ratio. The substantially intermediate voltage Vrefr therebetween is equal to 0.45V which is defined as a stoichiometric air-fuel ratio equivalent value. The exhaust air-fuel ratio can be detected in such a manner that, when the sensor output voltage is higher than Vrefr, the exhaust air-fuel ratio is richer than the stoichiometric air-fuel ratio and when the sensor output voltage is lower than Vrefr, the exhaust air-fuel ratio is leaner than the stoichiometric air-fuel ratio. In this way, the post-catalyst sensor 44 composed of the O₂ sensor, as compared to the output characteristic of the pre-catalyst sensor 42 composed of the wide-range air-fuel ratio sensor, has the output characteristic that the output variation is larger to an air-fuel ratio change in a predetermined air-fuel ratio region including the stoichiometric air-fuel ratio, preferably in an air-fuel ratio region extending by the substantially same degree in both of the lean side and the rich side around the stoichiometric air-fuel ratio. It should be noted that the post-catalyst sensor 44 is arbitrarily provided and may be removed.

In general, air-fuel ratio feedback control as the air-fuel ratio control is performed by the ECU 50 in such a manner that an air-fuel ratio of an exhaust gas flowing into the catalyst member 40 is controlled to be in the vicinity of a stoichiometric air-fuel ratio. The air-fuel ratio control is composed of main air-fuel ratio control (main air-fuel ratio feedback control) for making an exhaust air-fuel ratio detected based upon output of the pre-catalyst sensor 42 be equal to a stoichiometric air-fuel ratio as a target air-fuel ratio and assistant air-fuel ratio control (assistant air-fuel ratio feedback control) for making an exhaust air-fuel ratio detected based upon output of the post-catalyst sensor 44 be equal to a stoichiometric air-fuel ratio.

The engine 10 wholly controlled by the ECU 50 in this manner is provided with an apparatus 60 for detecting variation abnormality in an air-fuel ratio between cylinders in the first embodiment (hereinafter, called abnormality detecting apparatus).

The abnormality detecting apparatus 60 includes the pre-catalyst sensor 42, the third air-fuel ratio sensor 56, a part of the ECU 50 having a function as air-fuel ratio controlling means for controlling an exhaust air-fuel ratio as described above, and a part of the ECU 50 having a function as abnormality detecting means. The pre-catalyst sensor 42 is the wide-range air-fuel ratio sensor as described above and corresponds to first air-fuel ratio detecting means in the present invention. The third air-fuel ratio sensor 56 is constructed of a so-called O₂ sensor and corresponds to second air-fuel ratio detecting means in the present invention. In addition, the ECU 50 performs air-fuel ratio control for a predetermined period in such a manner as to make an exhaust air-fuel ratio be equal to an air-fuel ratio within the predetermined air-fuel ratio region based upon the output from the pre-catalyst sensor 42, making it possible to detect variation abnormality in an air-fuel ratio between cylinders based upon output for the predetermined period from the third air-fuel ratio sensor 56 at this time. Further, the ECU 50 includes a function of prerequisite determining means for determining whether or not a prerequisite for operations of the air-fuel ratio controlling means and the abnormality detecting means is satisfied. In addition to it, a part of the ECU 50 having a function as the abnormality detecting means includes both functions of value calculating means and determining means in regard to the present invention.

The third air-fuel ratio sensor 56 is constructed of the so-called O₂ sensor as described above and substantially has the same construction as the post-catalyst sensor 44. Therefore, the third air-fuel ratio sensor 56 has the output characteristic shown in FIG. 3 and has a characteristic that an output value thereof rapidly changes across a stoichiometric air-fuel ratio. In other words, the third air-fuel ratio sensor 56, as compared to the output characteristic of the pre-catalyst sensor 42 composed of the wide-range air-fuel ratio sensor, has the output characteristic that the output variation is larger to an air-fuel ratio change in a predetermined air-fuel ratio region including the stoichiometric air-fuel ratio, preferably in an air-fuel ratio region extending by the substantially same degree in each of the lean side and the rich side around the stoichiometric air-fuel ratio.

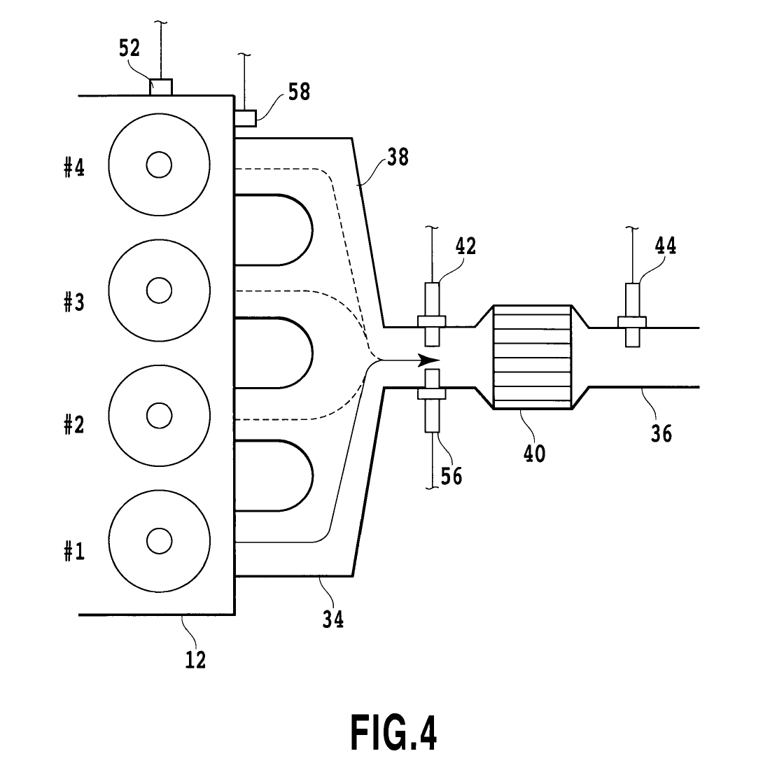

As shown in FIG. 4, the third air-fuel ratio sensor 56 is disposed in the exhaust passage upstream of the catalyst member 40 as the exhaust gas purifying apparatus. The third air-fuel ratio sensor 56 is disposed in the substantially same position as the pre-catalyst sensor 42. FIG. 4 schematically shows a flow of an exhaust gas from each cylinder, and it is to be understood that the exhaust gas reaches both of the third air-fuel ratio sensor 56 and the pre-catalyst sensor 42 in the same way.

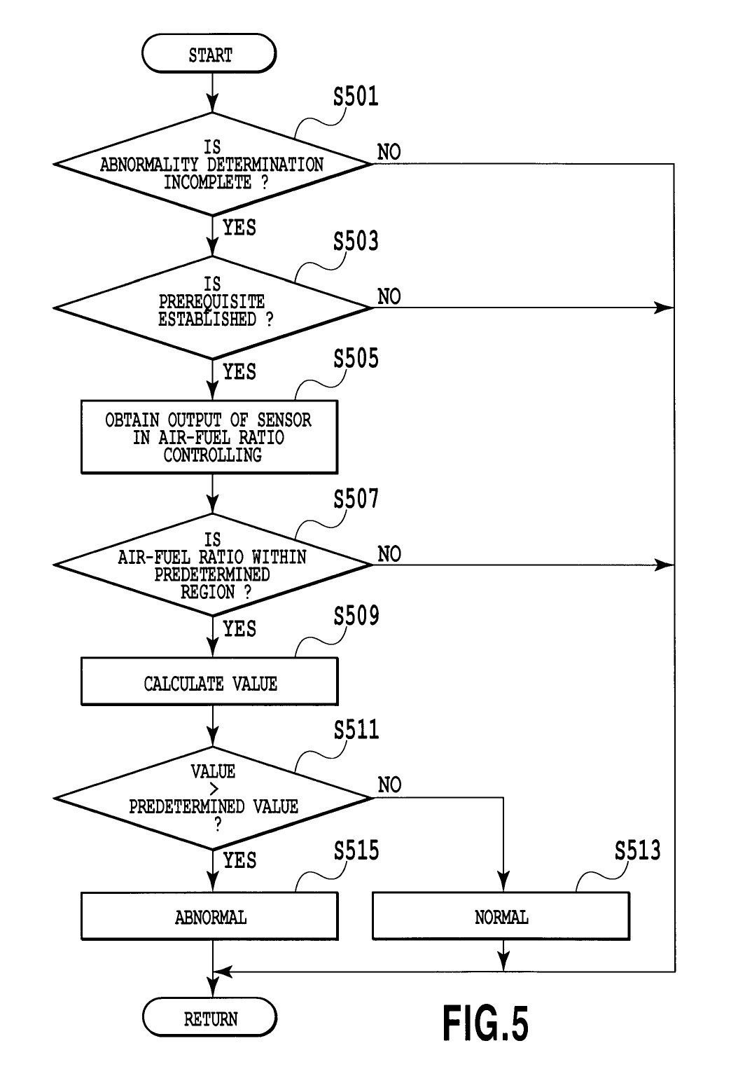

Hereinafter, detection of variation abnormality in an air-fuel ratio between cylinders in the first embodiment will be explained. FIG. 5 shows a routine for detecting the variation abnormality in the air-fuel ratio between the cylinders. The routine can be repeatedly executed by the ECU 50.

First, in step S501, it is determined whether or not determination on presence/absence of variation abnormality in an air-fuel ration between cylinders is incomplete. This determination is made based upon, for example, whether a flag is ON or OFF. In a case where the determination on the presence/absence of the variation abnormality in the air-fuel ration between the cylinders to be explained hereinafter had already made, a negative determination is made in step S501, and the routine ends. It should be noted that in the engine, such a determination is in principle made only one time after the engine starts. In a case where the determination on the presence/absence of the variation abnormality in the air-fuel ratio between the cylinders is incomplete, a positive determination is made in step S501.

In a case where the positive determination is made in step S501, it is determined in step S503 whether or not the prerequisite is established. The condition that the pre-catalyst sensor 42 is in an active state (active condition 1 or prerequisite 1), the condition that the third air-fuel ratio sensor 56 is in an active state (active condition 2 or prerequisite 2), the condition that the engine is in a predetermined operating state after the engine starts (prerequisite 3), and the like are defined as the prerequisite. The states of the pre-catalyst sensor 42 and the third air-fuel ratio sensor 56 are determined based upon the respective output. In addition, herein when all of the condition that the engine cooling water temperature is equal to or more than a predetermined temperature (prerequisite 4), the condition that the intake air quantity is within a predetermined intake air quantity range (prerequisite 5), and the condition that the engine rotational speed is within a predetermined engine rotational speed range (prerequisite 6) are satisfied, it is determined that the prerequisite 3 that the engine is in the predetermined operating state is satisfied. The predetermined temperature in the prerequisite 4 is, for example, 70° C. and may be a reference for determining completion of the engine warming-up. The predetermined intake air quantity range of the prerequisite 5 is, for example, 15 to 50 g/s and is defined in consideration of an influence of an exhaust gas on the output by the pre-catalyst sensor 42 and the third air-fuel ratio sensor 56. The predetermined engine rotational speed range of the prerequisite 6 is, for example, 1500 rpm to 2000 rpm and is defined in consideration of an influence of an exhaust gas on the output by the pre-catalyst sensor 42 and the third air-fuel ratio sensor 56. However, the prerequisite may be the other condition. For example, when at least one or two of the prerequisites 4 to 6 are satisfied, or when the other condition is satisfied in addition thereto, it may be determined that the prerequisite 3 is satisfied. When the prerequisite is not established, the negative determination is made in step S503, the routine ends. On the other hand, when the prerequisite is established, the positive determination is made in step S503.

When the positive determination is made in step S503, the output of the pre-catalyst sensor 42 and the output of the third air-fuel ratio sensor 56 are obtained in step S505. At this time, since the air-fuel ratio control is performed as described above, obtaining the output of these sensors is to obtain the output of the sensors in the middle of the air-fuel ratio controlling and is carried out for a predetermined period. The predetermined period is a period for which one cycle sequentially occurs in all of the plural cylinders in the engine 10, and in more detail, is a period for which one cycle composed of an intake stroke, a compression stroke, an explosion stroke (combustion expansion stroke), and an exhaust stroke occurs in all the cylinders from No. 1 to No. 4 (refer to FIG. 4). The predetermined period may be set longer than the above. The predetermined period is determined based upon output from the crank angle sensor 52. Herein the output of the pre-catalyst sensor 42 and the output of the third air-fuel ratio sensor 56 respectively are stored by being associated with the output from the crank angle sensor 52.

When the output of the pre-catalyst sensor 42 and the output of the third air-fuel ratio sensor 56 are obtained, it is determined in step S507 whether or not an exhaust air-fuel ratio obtained based upon the output from the pre-catalyst sensor 42 is within a predetermined air-fuel ratio region. The predetermined air-fuel ratio region is herein defined to include a stoichiometric air-fuel ratio, in other words, the predetermined air-fuel ratio region is defined as a region in which the output of the third air-fuel ratio sensor 56 can rapidly change when the exhaust air-fuel ratio changes slightly within the region. For example, the predetermined air-fuel ratio region may be defined as a region between an air-fuel ratio which is deviated by 0.5 to the lean side and an air-fuel ratio which is deviated by 0.5 to the rich side around the stoichiometric air-fuel ratio. When the prerequisite is satisfied, the operating state is generally a stationary state, and as described above, the air-fuel ratio control is performed by the ECU 50 in such a manner that the exhaust air-fuel ratio of the exhaust gas flowing into the catalyst member 40 is controlled to be in the vicinity of the stoichiometric air-fuel ratio based upon the output from the pre-catalyst sensor 42 and the post-catalyst sensor 44, that is, in such a manner as to make the exhaust air-fuel ratio be equal to the stoichiometric air-fuel ratio as the predetermined air-fuel ratio within the predetermined air-fuel ratio region. Therefore, the exhaust air-fuel ratio obtained based upon the output from the pre-catalyst sensor 42 is basically within the predetermined air-fuel ratio region. Therefore, step S507 may be omitted. When the exhaust air-fuel ratio is not within the predetermined air-fuel ratio region, the negative determination is made in step S507, and the routine ends. On the other hand, when the exhaust air-fuel ratio is within the predetermined air-fuel ratio region, the positive determination is made in step S507.

In a case where the positive determination is made in step S507, a value Val is calculated in step S509. The calculation of the value Val is made based upon the output of the third air-fuel ratio sensor 56 obtained for the predetermined period in step S505. In consequence, a value reflecting a change of the output of the third air-fuel ratio sensor 56 for the predetermined period, that is, a value corresponding to a variation amount of the output is calculated. This value may be a track length of output when the output of the third air-fuel ratio 56 is expressed in a predetermined two-dimensional map having a time axis, an integrated value of deviation amounts from the stoichiometric air-fuel ratio, an average value of the deviation amounts from the stoichiometric air-fuel ratio, or an average value or an absolute value of sensor output changing amounts.

In addition, in step S511 it is determined whether or not the value calculated in step S509 exceeds a predetermined value. The predetermined value is criteria and is defined as a constant herein, but may be variable in response to an intake air quantity and/or an engine rotational speed, and the like. In a case where the calculated value does not exceed the predetermined value, it is determined in step S513 that the variation abnormality in the air-fuel ratio between the cylinders does not occur as normal, and the routine ends.

On the other hand, in a case where it is determined that the value calculated in step S509 exceeds the predetermined value, the positive determination is made in step S511, and it is determined in step S515 that the variation abnormality in the air-fuel ratio between the cylinders occurs as abnormal, and the routine ends. When it is determined that the variation abnormality in the air-fuel ratio between the cylinders occurs, a warning lamp disposed on a front panel of a driver's seat or the like turns on. As a result, a driver can be prompted to perform an inspection or repair of the engine 10.

It should be noted that by execution of step S511, for example, a determination completion flag is made ON. Accordingly, in step S501 in the routine of the next time and after, the negative determination is made by determining that the determination on the presence/absence of the variation abnormality in the air-fuel ratio between the cylinders is completed.

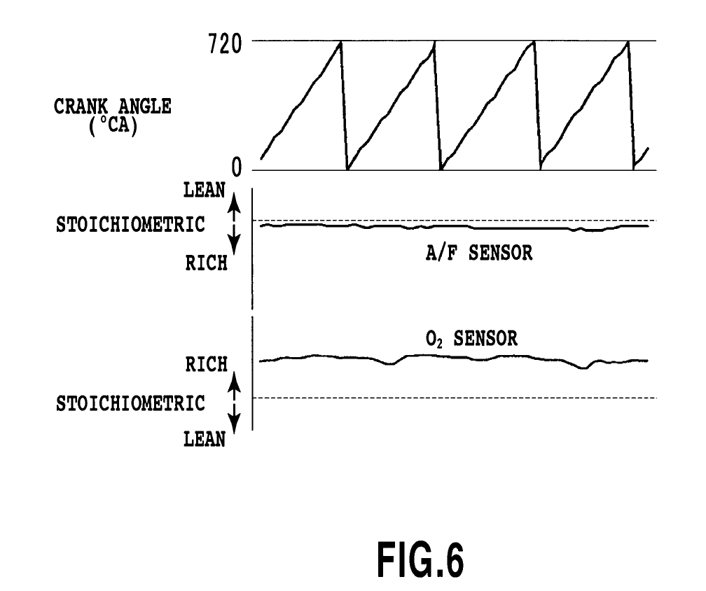

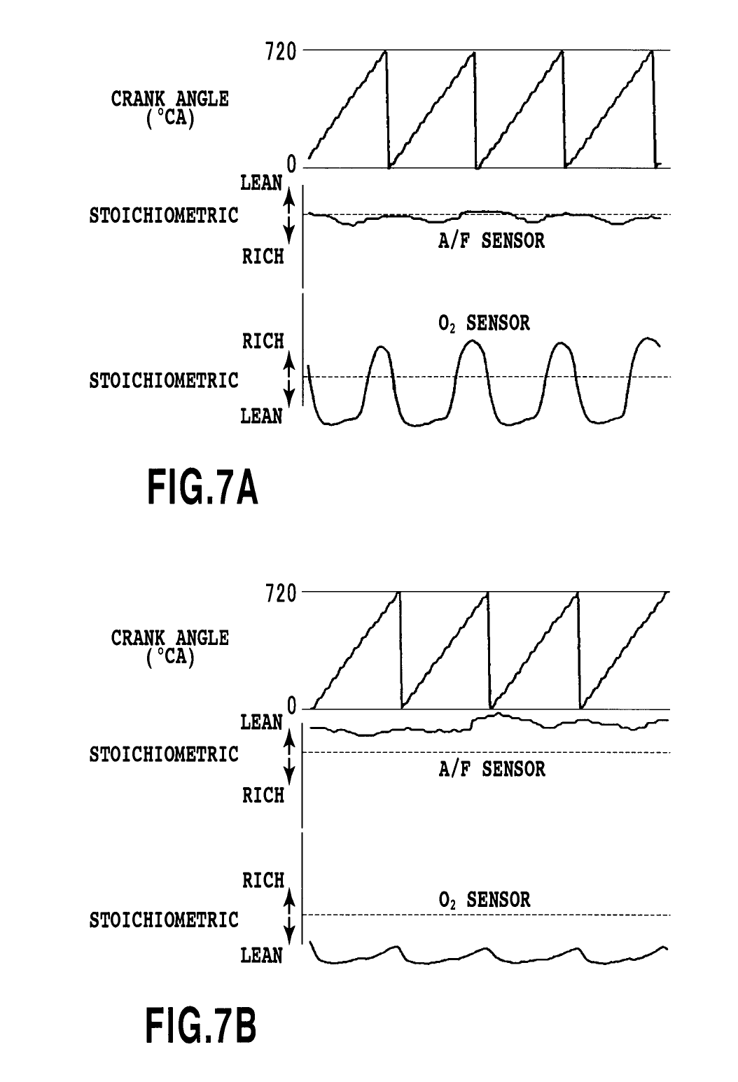

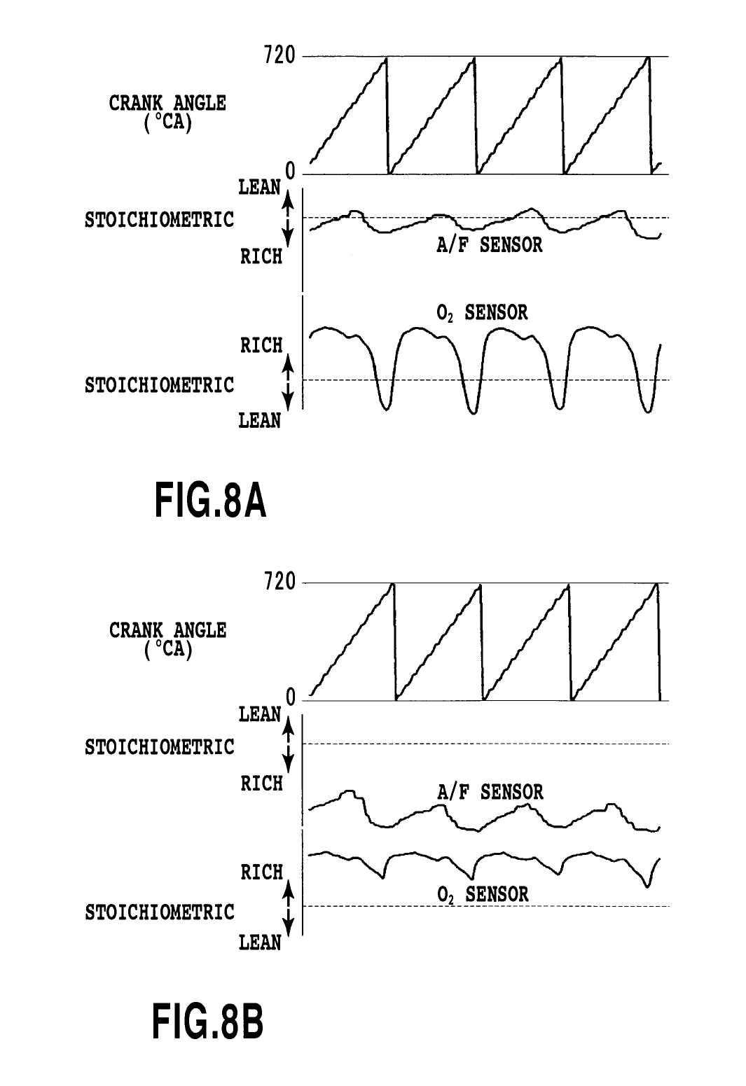

Herein a relation between output from the wide-range air-fuel ratio sensor and output from the O₂ sensor will be explained with reference to FIG. 6, FIG. 7A, FIG. 7B, FIG. 8A, and FIG. 8B. Each of FIG. 6 to FIG. 8B is experiment data in regard to a one-half bank of a V8-type engine. Each of FIG. 6 to FIG. 8B is a graph expressed by associating output from a wide-range air-fuel ratio sensor (A/F sensor in the figure) provided downstream of an exhaust gas merging portion in which four exhaust branch pipes communicated with four cylinders respectively merge and output from the O₂ sensor provided in the substantially same position with output from the crank angle sensor. The wide-range air-fuel ratio sensor herein corresponds to the aforementioned pre-catalyst sensor 42 used for the air-fuel ratio control and the O₂ sensor herein corresponds to the aforementioned third air-fuel ratio sensor 56.

However, the wide-range air-fuel ratio sensor herein corresponds to the aforementioned pre-catalyst sensor 42 used for the air-fuel ratio control, and in the experiment, the air-fuel ratio control is performed in such a manner as to make the exhaust air-fuel ratio of the engine be equal to the set target air-fuel ratio based upon the output from the wide-range air-fuel ratio sensor. That is, the air-fuel ratio feedback control is performed in such a manner as to make the air-fuel ratio detected based upon the output from the wise-range air-fuel ratio sensor be equal to the set target air-fuel ratio. In addition, the output from the wide-range air-fuel ratio sensor and the output of the O₂ sensor in the middle of the air-fuel ratio controlling are expressed in each of FIG. 6 to FIG. 8B.

FIG. 6 is data of a case where the air-fuel ratio control is performed in such a manner that an exhaust air-fuel ratio is made to be equal to a stoichiometric air-fuel ratio, that is, a theoretical air-fuel ratio in regard to an engine when there occurs no variation abnormality in an air-fuel ratio between cylinders. On the other hand, FIG. 7A to FIG. 8B relate to an engine in which there occurs variation abnormality in an air-fuel ratio between cylinders. FIG. 7A and FIG. 7B are data in a case where an injection quantity Qa by an injector in regard to one cylinder is smaller by 30% (=((Qa−Qb)/Qb)×100) than an injection quantity Qb by each of injectors by the other three normal cylinders. In addition, FIG. 7A is data in a case where the air-fuel ratio control is performed in such a manner that the exhaust air-fuel ratio is made to be equal to a stoichiometric air-fuel ratio, and FIG. 7B is data in a case where the air-fuel ratio control is performed in such a manner that the exhaust air-fuel ratio is made to be equal to a lean air-fuel ratio. FIG. 8A and FIG. 8B are data in a case where an injection quantity Qa by an injector in regard to one cylinder is larger by 60% than an injection quantity Qb by each of injectors by the other three normal cylinders. In addition, FIG. 8A is data in a case where the air-fuel ratio control is performed in such a manner that the exhaust air-fuel ratio is made to be equal to a stoichiometric air-fuel ratio, and FIG. 8B is data in a case where the air-fuel ratio control is performed in such a manner that the exhaust air-fuel ratio is made to be equal to a rich air-fuel ratio.

By comparing the data of FIG. 6 to FIG. 8B, it can be understood that the air-fuel ratio control is performed for the predetermined period in such a manner that the exhaust air-fuel ratio is made to be equal to the air-fuel ratio within the predetermined air-fuel ratio region including the stoichiometric air-fuel ratio as described above, preferably the stoichiometric air-fuel ratio, making it possible to detect the variation abnormality in the air-fuel ratio between the cylinders based upon the output from the O₂ sensor for the predetermined period.

Here, consideration will be made on an engine based upon FIG. 6, FIG. 7A and FIG. 7B, in which there occurs variation abnormality in an air-fuel ratio between cylinders since the injection quantity Qa by the injector in regard to one cylinder is smaller by 30% than the injection quantity Qb by each of the injectors by the other three normal cylinders. In this case, when the air-fuel ratio control is performed for a predetermined period in such a manner that the exhaust air-fuel ratio is made to be equal to a stoichiometric air-fuel ratio based upon the output of the wide-range air-fuel ratio sensor, the output of the wide-range air-fuel ratio sensor is stable in the vicinity of the stoichiometric air-fuel ratio, but the output of the O₂ sensor varies largely. This means that in the engine where there occurs variation abnormality in an air-fuel ratio between cylinders, the value obtained from the output of the O₂ sensor (step S509) becomes large. It should be noted that such an inclination occurs because the air-fuel ratio control is performed in such a manner that the exhaust air-fuel ratio is made to be equal to a stoichiometric air-fuel ratio based upon the output of the wide-range air-fuel ratio sensor, and the O₂ sensor has the output characteristic that the output largely changes due to the air-fuel ratio change in the vicinity of the stoichiometric air-fuel ratio.

On the other hand, consideration will be made on an engine based upon FIG. 6, FIG. 8A and FIG. 8B, in which there occurs variation abnormality in an air-fuel ratio between cylinders since the injection quantity Qa by the injector in regard to one cylinder is larger by 60% than the injection quantity Qb by each of the injectors by the other three normal cylinders. In this case, when the air-fuel ratio control is performed for a predetermined period in such a manner that the exhaust air-fuel ratio is made to be equal to a stoichiometric air-fuel ratio based upon the output of the wide-range air-fuel ratio sensor, the output of the wide-range air-fuel ratio sensor is stable in the vicinity of the stoichiometric air-fuel ratio, but the output of the O₂ sensor varies largely. This means that in the engine where there occurs the variation abnormality in the air-fuel ratio between the cylinders, the value obtained from the output of the O₂ sensor (step S509) becomes large. It should be noted that such an inclination occurs likewise because the air-fuel ratio control is performed in such a manner that the exhaust air-fuel ratio is made to be equal to the stoichiometric air-fuel ratio based upon the output of the wide-range air-fuel ratio sensor, and the O₂ sensor has the output characteristic that the output largely changes due to the air-fuel ratio change in the vicinity of the stoichiometric air-fuel ratio.

In consequence, the air-fuel ratio control is performed for the predetermined period in such a manner that the exhaust air-fuel ratio is made to be equal to the stoichiometric air-fuel ratio based upon the output of the wide-range air-fuel ratio sensor, and the variation abnormality in the air-fuel ratio between the cylinders can be detected based upon the output of the O₂ sensor provided in the same position as the wide-range air-fuel ratio sensor at this time. In addition, this is, as shown in the experiment data of FIG. 6 to FIG. 8B, sufficiently applicable even to the internal combustion engine which has a plurality of cylinders and sequentially repeats the explosion strokes by irregular intervals.

It should be noted that from the experiment data of FIG. 6 to FIG. 8B and the like, it is to be understood that a target air-fuel ratio in the air-fuel ratio control for detecting variation abnormality in an air-fuel ratio between cylinders is not limited to a stoichiometric air-fuel ratio. It is to be understood that the target air-fuel ratio in the air-fuel ratio control for detecting the variation abnormality in the air-fuel ratio between the cylinders can be defined by a degree of the variation abnormality in the air-fuel ratio between the cylinders which is desired to be detected, that is, detection accuracy of the variation abnormality in the air-fuel ratio between the cylinders or can be defined within a predetermined air-fuel ratio region including an air-fuel ratio region in which the output of the O₂ sensor changes by a predetermined amount or more, that is, changes rapidly.

Next, a second embodiment in the present invention will be explained. The second embodiment differs in control and calculation for detecting variation abnormality in an air-fuel ratio between cylinders from the first embodiment. Therefore, hereinafter, only the feature in the second embodiment in regard thereto will be explained. It should be noted that since components of an internal combustion engine according to the second embodiment are substantially the same as those in the internal combustion engine 10 according to the first embodiment, an explanation of the components is omitted hereinafter.

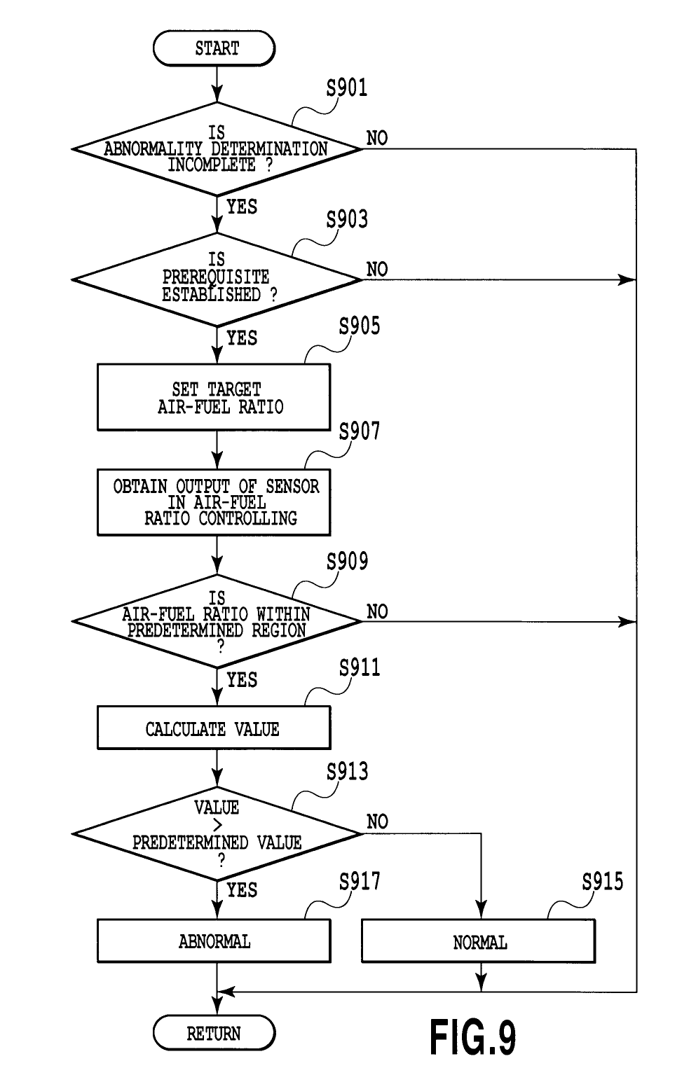

An explanation will be made on detection of variation abnormality in an air-fuel ratio between cylinders according to the second embodiment. FIG. 9 shows a routine for detecting the variation abnormality in the air-fuel ratio between the cylinders according to the second embodiment. The routine can be repeatedly executed by the ECU 50. However, steps S901, S903, and S907 to S917 in FIG. 9 respectively correspond to steps S501 to S515. Therefore, hereinafter, in regard to steps S901, S903, and S907 to S917 in FIG. 9, only difference points from the corresponding steps S501 to S515 will be explained.

In a case where the prerequisite is established (positive determination in step S903), a target value in the air-fuel ratio control is set to a predetermined air-fuel ratio. The predetermined air-fuel ratio may be a fixed value such as a stoichiometric air-fuel ratio, but herein varies as needed.

In addition, after the air-fuel ratio control starts to be performed in such a manner that an exhaust air-fuel ratio is made to be equal to the set predetermined air-fuel ratio, in step S907 the output of the pre-catalyst sensor 42 and the output of the third air-fuel ratio sensor 56 in the middle of the air-fuel ratio controlling are obtained for a predetermined period in the same way as in step S505. Obtaining the output of the sensor in step S907 may start immediately after the air-fuel ratio control starts to be performed in such a manner that the exhaust air-fuel ratio is made to be equal to the predetermined air-fuel ratio, but is preferably performed after a period elapses on some level. This is because the sensor output after the exhaust air-fuel ratio becomes stable on some level in the air-fuel ratio control is used for the following steps.

Thereafter, in step S909 it is determined whether or not the exhaust air-fuel ratio obtained based upon the output from the pre-catalyst sensor 42 is within a predetermined air-fuel ratio region. The predetermined air-fuel ratio region can be constant, but is set to be variable in the same way as the target air-fuel ratio in step S905. In a case where the exhaust air-fuel ratio is within the predetermined air-fuel ratio region, the positive determination is made instep S909, and steps subsequent to step S911 are executed.

Here, the predetermined air-fuel ratio in step S905 and the predetermined air-fuel ratio region in step S909 will be explained.

As apparent from the above explanation, the so-called O₂ sensor has a Z characteristic as shown in FIG. 3 to the so-called wide-range air-fuel ratio sensor. Therefore, in an air-fuel ratio region in which an air-fuel ratio is deviated to be richer or leaner on some level around the stoichiometric air-fuel ratio, the output from the O₂ sensor is difficult to change even if the exhaust air-fuel ratio varies. Therefore, even if there occurs the variation abnormality in the air-fuel ratio between the cylinders, the variation amount of the O₂ sensor for the predetermined period does not increase in such an air-fuel ratio region. Therefore, for avoiding such an event, it is necessary to control the exhaust air-fuel ratio to a predetermined air-fuel ratio, which is the same as described in the first embodiment.

However, the degree of the variation abnormality in the air-fuel ratio between the cylinders which is desired to be detected can change corresponding to an internal combustion engine or the like. Further, even if a fuel injection quantity of the injector 32 varies, it is not preferable that it is determined that there occurs the variation abnormality in the air-fuel ratio between the cylinders also in a case where the variation is within an allowance error of the injection quantity of the injector 32. Accordingly, based upon such a view, herein the predetermined air-fuel ratio in step S905 and the predetermined air-fuel ratio region in step S909 are set to be variable.

First, a range of a target air-fuel ratio, that is, a predetermined air-fuel ratio region in the air-fuel ratio control in response to the level of variation abnormality in an air-fuel ratio between cylinders which is desired to be detected, that is, detection accuracy of the variation abnormality in the air-fuel ratio between the cylinders (step S909) will be explained. Here, consideration will be made on a four-cylinder engine of a type as shown in FIG. 1. It should be noted that such a four-cylinder engine may be thought as a one-half bank of a V 8 engine.

Among the four cylinders, it is assumed that there occurs abnormality in one cylinder alone. When among the four cylinders, an exhaust air-fuel ratio by the three normal cylinders is indicated at X, an exhaust air-fuel ratio by the abnormal cylinder is indicated at Y (=R·X), and a target air-fuel ratio in air-fuel ratio feedback control is indicated at Z, these elements have a relation of Equation (1).

$$\begin{matrix}[ Equation 1 ] & \\ Z = \frac{3 \cdot X + Y}{4} & ( 1 )\end{matrix}$$

Here, consideration will be made on a case where an exhaust air-fuel ratio by one abnormal cylinder is deviated to be leaner than an exhaust air-fuel ratio by the normal cylinder. In this case, for increasing a variation amount of the sensor output of the O₂ sensor to detect variation abnormality in an air-fuel ratio between cylinders, it is necessary to establish a relation of “X<14.6 and Y>14.6”. This is because the output of the O₂ sensor rapidly changes across a stoichiometric air-fuel ratio (herein the stoichiometric A/F=14.6) around it. A relation of Equation (2) is induced from this relation and Equation (1).

$$\begin{matrix}[ Equation 2 ] & \\ \frac{14.6 ( 3 + R )}{4 \cdot R} < Z < \frac{14.6 ( 3 + R )}{4} & ( 2 )\end{matrix}$$

On the other hand, consideration will be made on a case where the exhaust air-fuel ratio by one abnormal cylinder is deviated to be richer than the exhaust air-fuel ratio by the normal cylinder. In this case, for increasing a variation amount of the sensor output of the O₂ sensor to detect variation abnormality in an air-fuel ratio between cylinders, it is necessary to establish a relation of “X>14.6 and Y<14.6” for the same reason. A relation of Equation (3) is induced from this relation and Equation (1).

$$\begin{matrix}[ Equation 3 ] & \\ \frac{14.6 ( 3 + R )}{4} < Z < \frac{14.6 ( 3 + R )}{4 \cdot R} & ( 3 )\end{matrix}$$

An air-fuel ratio area satisfying the relation of Equation (2) or Equation (3) described above is induced as a range of the target air-fuel ratio Z in the air-fuel ratio control in response to the level of variation abnormality in an air-fuel ratio between cylinders which is desired to be detected. For example, in a case where the exhaust air-fuel ratio by one abnormal cylinder is deviated to be leaner than the exhaust air-fuel ratio by the normal cylinder and the deviation rate R is 1.1, 1.2 or 1.5, a range of “13.60<Z<14.97”, “12.78<Z<15.33”, or “10.95<Z<16.43” to each R is induced from Equation (2).

For example, “12.78<Z<15.33” in a case where the deviation rate R is 1.2 is an effective range region of a target air-fuel ratio in a case of determining presence/absence of an abnormal cylinder in which the deviation rate R is larger than 1.2. Therefore, the air-fuel ratio control is performed by setting the target air-fuel ratio to an air-fuel ratio within this region and performing the air-fuel ratio control to obtain output from the O₂ sensor 56, thus determining variation abnormality in an air-fuel ratio between cylinders. Therefore, it is possible to appropriately determine the presence/absence of the abnormal cylinder in which the deviation rate R to the leaner side is larger than 1.2. In this case, the target predetermined air-fuel ratio in step S905 may be set arbitrarily from the range region larger than 12.78 and less than 15.33, and the predetermined air-fuel ratio region in step S909 may be set in the same region.

Such a setting region of the target air-fuel ratio may be variable in response to a cumulative operating time of the engine. For example, when the engine is one similar to a new engine, this region may be set to be narrow, and thereafter, may be widely changed in response to a cumulative operating time of the internal combustion engine, a traveling distance of the vehicle or the like. In addition, setting the target air-fuel ratio within such a region can be carried out based upon an operating condition at each time or the latest target air-fuel ratio in the air-fuel ratio control. This is because it is not preferable to overly deviate the target air-fuel ratio out of the current state of the engine.

In addition, when there occurs variation abnormality in an air-fuel ratio between cylinders, whether an exhaust air-fuel ratio due to the abnormal cylinder is deviated to a leaner side or a richer side to an exhaust air-fuel ratio due to a normal cylinder can differ depending on a characteristic of the injector and a characteristic of the internal combustion engine. Therefore, a predetermined air-fuel ratio region and a target air-fuel ratio may be set based upon only one of the relation of Equation (2) and the relation of Equation (3), or the predetermined air-fuel ratio region and the target air-fuel ratio may be set based upon both of the relation of Equation (2) and the relation of Equation (3).

On the other hand, a target air-fuel ratio and a predetermined air-fuel ratio region in the air-fuel ratio control in a case where an injection quantity of the injector 32 is deviated within a range of an allowance error will be explained. Here, consideration will be made on a four-cylinder engine of a type as shown in FIG. 1. It should be noted that such a four-cylinder engine may be assumed as a one-half bank of a V 8 engine.

Among the four cylinders, it is assumed that only an injection quantity of the injector in regard to one cylinder among the four cylinders is deviated within the range of the allowance error. When among the four cylinders, an exhaust air-fuel ratio of the three cylinders each not having such a deviation is indicated at p, an exhaust air-fuel ratio of the cylinder having such a deviation is indicated at q (=r·p), and a target air-fuel ratio in air-fuel ratio feedback control is indicated at z, these elements have a relation of Equation (4).

$$\begin{matrix}[ Equation 4 ] & \\ z = \frac{3 \cdot p + q}{4} & ( 4 )\end{matrix}$$

Here, consideration will be made on a case where the injection quantity from the injector in which the injection quantity is deviated within the allowance error is smaller than the injection quantity of the other injector and the exhaust air-fuel ratio by the cylinder provided with the injector in which the injection quantity is deviated within the allowance error is deviated to a leaner side than the exhaust air-fuel ratio by the other cylinder. In this case, for avoiding that it is determined that there occurs variation abnormality in an air-fuel ratio between cylinders, it is necessary to establish a relation of “p>14.6 or q<14.6”. It should be noted that, for furthermore certainly avoiding such a determination, for example, a relation of “p>14.7 or q<14.7” may be used. This is because of not positioning a region where the output of the O₂ sensor rapidly changes between the exhaust air-fuel ratio from the cylinder having the injector in which the injection quantity is deviated within the allowance error and the exhaust air-fuel ratio from the other injector. A relation of “Equation (5) or Equation (6)” is induced from this relation and Equation (4).

$$\begin{matrix}[ Equation 5 ] & \\ z < \frac{14.6 ( 3 + r )}{4 \cdot r} & ( 5 ) \\ [ Equation 6 ] & \\ z > \frac{14.6 ( 3 + r )}{4} & ( 6 )\end{matrix}$$

By setting the target air-fuel ratio within the region satisfying the relation of Equation (5) or Equation (6), it is possible to avoid that it is determined that there occurs variation abnormality in an air-fuel ratio between cylinders by the deviation of such an injection quantity of the injector. In addition, such a relation may be used independently, but herein is used as combined with the relation of Equation (2).

For example, when the allowance error in the injection quantity of the injector is 0.02%, that is, when r is 1.02, a range of “z<14.39 or z>14.67” is induced from Equation (5) and Equation (6). From this range and the above relation, that is, a range of “12.78<z<15.33” in a case where the deviation rate R by which the exhaust air-fuel ratio due to one abnormal cylinder is deviated to a leaner side than the exhaust air-fuel ratio due to the normal cylinder is 1.2, a range of “12.78<z<14.39” or “14.67<z<15.33” can be induced.

This region is defined as the predetermined air-fuel ratio region in step S909, and the predetermined air-fuel ratio in step S905 can be set from this region. In addition, the air-fuel ratio control is performed based upon this, and determination in step S913 is made based upon the output from the O₂ sensor. Thereby, it is possible to determine the presence/absence of the abnormal cylinder in which the deviation rate R is larger than 1.2 and it is possible to eliminate detection of existence of the cylinder in which the deviation of the injection quantity within the allowance error occurs.

It should be noted that, also in regard to a case where the injection quantity from the injector in which the injection quantity is deviated within the allowance error is smaller than the injection quantity of the other injector and the exhaust air-fuel ratio by the cylinder provided with the injector in which the injection quantity is deviated within the allowance error is deviated to a richer side than the exhaust air-fuel ratio by the other cylinder, the air-fuel ratio region z can be similarly induced. The explanation herein is omitted.

Since setting and selecting the target air-fuel ratio within the air-fuel ratio region found in this manner is similar to the explanation in the air-fuel ratio control in accordance with the level of the variation abnormality in the air-fuel ratio between the cylinders which is desired to be detected, the explanation herein is omitted. The setting and selecting the target air-fuel ratio within the air-fuel ratio region can be arbitrarily carried out. However, the selection condition may be set by experiments or the like in such a manner as not to impose an adverse effect on an operation of the internal combustion engine 10.

It should be noted that, the target predetermined air-fuel ratio in step S905 and the predetermined air-fuel ratio region in step S909 may be set by experiments and be variable in accordance with an operating condition or the like at each time.

Next, a third embodiment in the present invention will be explained. The third embodiment differs in control and calculation for detecting variation abnormality in an air-fuel ratio between cylinders from the first embodiment. Therefore, hereinafter, only the feature in the third embodiment in regard thereto will be explained. It should be noted that since components of an internal combustion engine according to the third embodiment are substantially the same as those in the internal combustion engine 10 according to the first embodiment, an explanation of the components is omitted hereinafter.

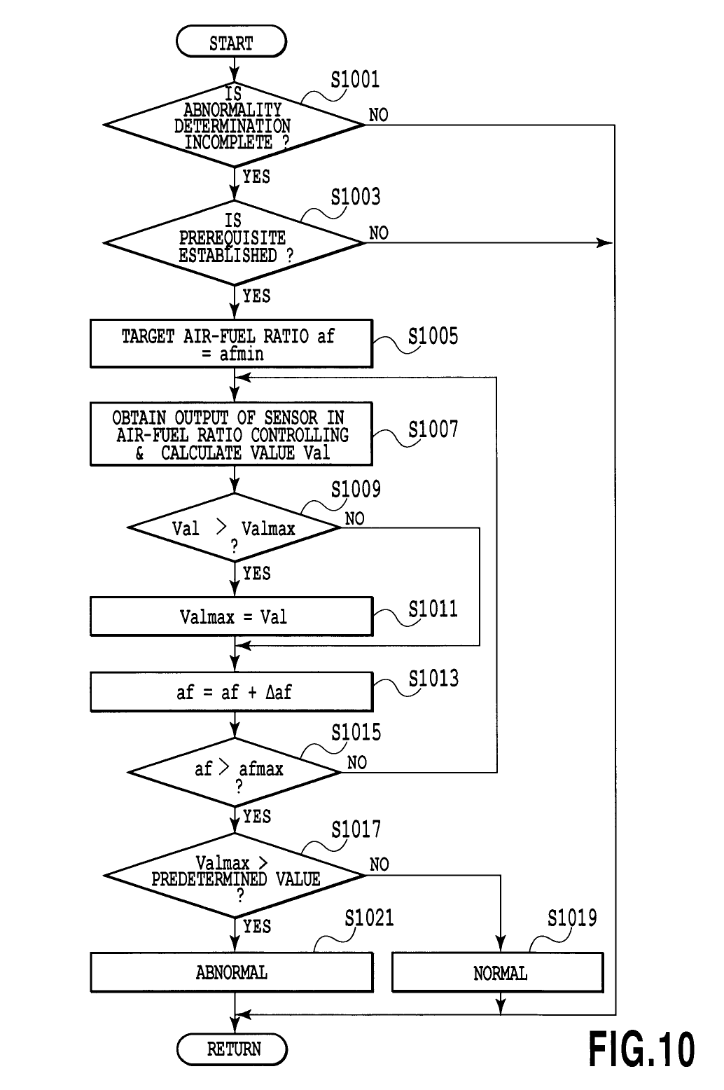

An explanation will be made on detection of variation abnormality in an air-fuel ratio between cylinders according to the third embodiment. FIG. 10 shows a routine for detecting the variation abnormality in the air-fuel ratio between the cylinders according to the third embodiment. The routine can be repeatedly executed by the ECU 50. However, steps S1001, S1003, and S1017 to S1021 in FIG. 10 respectively substantially correspond to steps S501, S503, and S511 to S515. Therefore, hereinafter, in regard to steps S1001, S1003, and S1017 to S1021, only difference points from steps S501, S503, and S511 to S515 will be explained.

Also in the third embodiment, as in the case of the first embodiment, there is detected variation abnormality in an air-fuel ratio between cylinders based upon the output from the third air-fuel ratio sensor 56 at the time of performing the air-fuel ratio control in such a manner as to make an exhaust air-fuel ratio be equal to a predetermined air-fuel ratio based upon the output from the pre-catalyst sensor 42. However, there can be some cases where the output characteristic of the pre-catalyst sensor 42, that is, the wide-range air-fuel ratio sensor is deviated within a range of the allowance error. In such a case, there can be some cases where the exhaust air-fuel ratio is difficult to be controlled to the predetermined air-fuel ratio, preferably a stoichiometric air-fuel ratio and even if there occurs the variation abnormality in the air-fuel ratio between the cylinders, there can be some cases where a large change does not possibly occur in the output of the third air-fuel ratio sensor. Therefore, in the third embodiment, the air-fuel ratio control is performed for a predetermined period in such a manner that a target value of the air-fuel ratio control is gradually changed within a predetermined air-fuel ratio region and the exhaust air-fuel ratio is made to be equal to each of the plurality of the target air-fuel ratios. Based upon the output from the third air-fuel ratio sensor 56 at the time of performing the air-fuel ratio control to each of the plurality of the target air-fuel ratios, values reflecting a change of the output are calculated. The maximum value is selected from the calculated values, and presence/absence of the variation abnormality in the air-fuel ratio between the cylinders is determined on whether or not the maximum value exceeds a predetermined value. Therefore, the ECU 50 further has a function of maximum value selecting means herein. Hereinafter, such detection of the variation abnormality in the air-fuel ratio between the cylinders in the third embodiment will be explained with reference to FIG. 10.

In a case where the prerequisite is established (positive determination in step S1003), a target air-fuel ratio of is set to a minimum air-fuel ratio afmin in step S1005. The minimum air-fuel ratio afmin is a minimum value in a predetermined air-fuel ratio region in advance set by experiments and the like. The ECU 50 performs the air-fuel ratio control for a predetermined period in such a manner as to make the exhaust air-fuel ratio be equal to the set minimum air-fuel ratio afmin.

At the time of performing the air-fuel ratio control for the predetermined period in such a manner as to make the exhaust air-fuel ratio be equal to the minimum air-fuel ratio afmin, in step S1007 the sensor output is obtained in the same way as in step S505, and the value Val is calculated in the same way as in step S509.

In addition, in step S1009 it is determined whether or not the value Val calculated in step S1007 exceeds a maximum value Valmax. The maximum value Valmax is set to zero as an initial value.

When in step S1009 a positive determination is made by determining that the value Val exceeds the maximum value Valmax, the maximum value Valmax is rewritten and updated by the value Val in step S1011. On the other hand, when in step S1009 of the routine to be described later, a negative determination is made by determining that the value Val does not exceed the maximum value Valmax, step S1011 is skipped.

Thereafter, in step S1013 a predetermine changing amount Δaf is added to the target air-fuel ratio af at this time to update the target air-fuel ration af. In step S1015 it is determined whether or not the updated target air-fuel ratio af exceeds the maximum air-fuel ratio afmax. The maximum air-fuel ratio afmax is a maximum value in the predetermined air-fuel ratio region in advance set by experiments or the like. In addition, when in step S1015 a negative determination is made by determining that the target air-fuel ratio af does not exceed the maximum air-fuel ratio afmax, the process goes again to step S1007 for the ECU 50 to perform the air-fuel ratio control for a predetermined period in such a manner as to make the exhaust air-fuel ratio be equal to the updated target air-fuel ratio af. In this manner, the aforementioned air-fuel ratio control is repeated to each of the plurality of the target air-fuel ratios until the target air-fuel ratio af exceeds the maximum air-fuel ratio afmax, and the calculation and update of the values Val and Valmax to these are repeated.

When in step S1015 a positive determination is made by determining that the target air-fuel ratio af updated in step S1015 exceeds the maximum air-fuel ratio afmax, in step S1015 it is determined whether or not the maximum value Valmax selected from the plurality of the values Val calculated so far exceeds a predetermined value. The determination substantially corresponds to determination on presence/absence of variation abnormality in an air-fuel ratio between cylinders, which is as described above.

Next, a fourth embodiment in the present invention will be explained. The fourth embodiment differs in a point of adding a point where it is determined whether or not there occurs abnormality in the pre-catalyst sensor 42, that is, the wide-range air-fuel ratio sensor and in a case where such abnormality occurs, detection of variation abnormality in an air-fuel ratio between cylinders is inhibited, from the third embodiment. Therefore, hereinafter, only the feature in the fourth embodiment in regard thereto will be explained. It should be noted that since components of an internal combustion engine according to the fourth embodiment are substantially the same as those in the internal combustion engine 10 according to the first embodiment, an explanation of the components is omitted hereinafter.

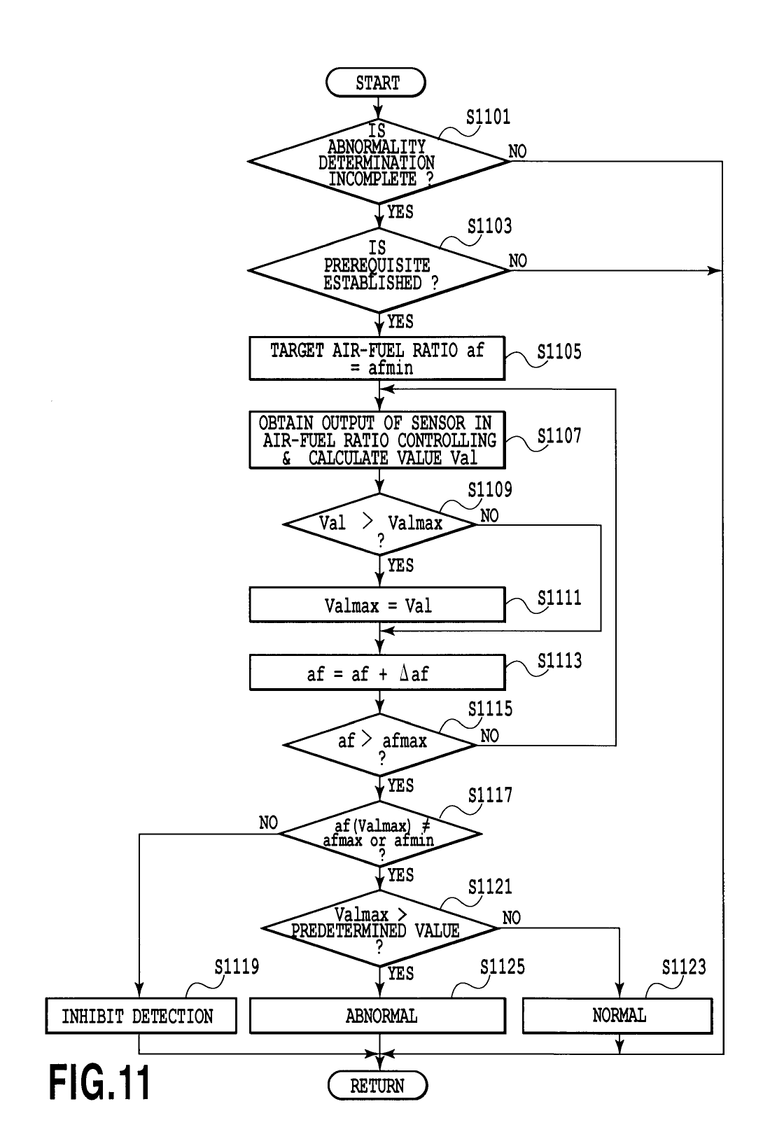

An explanation will be made on detection of variation abnormality in an air-fuel ratio between cylinders according to the fourth embodiment. FIG. 11 shows a routine for detecting the variation abnormality in the air-fuel ratio between the cylinders according to the fourth embodiment. The routine can be repeatedly executed by the ECU 50. However, steps S1101 to S1115, and S1121 to S1125 in FIG. 11 respectively correspond to steps S1001 to S1021. Therefore, hereinafter, in regard to steps S1101 to S1115, and S1121 to S1125, only difference points from the corresponding steps S1001 to S1021 will be explained.

When the prerequisite is satisfied, a target air-fuel ratio af is set to each of a plurality of target air-fuel ratios within a predetermined air-fuel ratio region to repeat the aforementioned air-fuel ratio control and the calculation and update of the values Val and Valmax to these are repeated. When a positive determination is made by determining that the target air-fuel ratio af updated in step S1115 exceeds the maximum air-fuel ratio afmax, in step S1117 an air-fuel ratio af (Valmax) as a target in the air-fuel ratio control corresponding to the value Val made to the maximum value Valmax is read and it is determined whether or not the air-fuel ratio af (Valmax) does not correspond to any of the maximum air-fuel ratio afmax and the minimum air-fuel ratio afmin. When in step S1117 a negative determination is made by determining that the target air-fuel ratio af (Valmax) is the maximum air-fuel ratio afmax or the minimum air-fuel ratio afmin, detection of variation abnormality in an air-fuel ratio between cylinders is inhibited in step S1119. Therefore, a warning lamp arranged in a front panel of the driver's seat or the like is turned on. In consequence, a driver can be prompted to perform an inspection or a repair of the internal combustion engine 10.

The predetermined air-fuel ratio region is defined in consideration of the allowance error of the pre-catalyst sensor 42 as the wide-range air-fuel ratio sensor. Meanwhile, in a case where there is no error in any of the pre-catalyst sensor 42 and the third air-fuel ratio sensor 56, the maximum value Valmax is theoretically supposed to relate to the air-fuel ratio control performed in such a manner as to set a stoichiometric air-fuel ratio as a target air-fuel ratio. Therefore, in a case where the target air-fuel ratio af (Valmax) is the maximum air-fuel ratio afmax or the minimum air-fuel ratio afmin, the case substantially corresponds to the event that an error in the output of the pre-catalyst sensor 42 exceeds the allowance error. That is, this means that a deviation amount from a reference air-fuel ratio (herein stoichiometric air-fuel ratio) in regard to the air-fuel ratio af (Valmax) exceeds a predetermined deviation amount corresponding to the allowance error of the pre-catalyst sensor 42. Therefore, herein assuming that the air-fuel ratio control can not be appropriately performed due to occurrence of the abnormality in the pre-catalyst sensor 42 at this time, the ECU 50 inhibits detection of the variation abnormality in the air-fuel ratio between the cylinders. That is, the ECU 50 has a function of inhibiting means for inhibiting detection of step S1121.

It should be noted that a difference to the reference air-fuel ratio, for example, a theoretical air-fuel ratio in the air-fuel ratio of (Valmax) is found and in step S1117 there may be made alternatively determination on whether or not this difference exceeds a predetermined value. In this manner, it can be likewise highly accurately determined whether or not the error in the pre-catalyst sensor 42 exceeds the allowance error. In addition, in this case, the minimum air-fuel ratio afmin in step S1105 may be made smaller than the minimum air-fuel ratio afmin in step S1005, and the maximum air-fuel ratio afmax in step S1115 may be made larger than the maximum air-fuel ratio in step S1015.

Next, a fifth embodiment in the present invention will be explained. The fifth embodiment differs in a point where a heater is provided as heating means in the third air-fuel ratio sensor as the O₂ sensor and the heater is operated at an appropriate time in regard to detection of variation abnormality in an air-fuel ratio between cylinders, from the first embodiment. Therefore, hereinafter, only the feature in the fifth embodiment in regard thereto will be explained. It should be noted that since components of an internal combustion engine according to the fifth embodiment are substantially the same as those in the internal combustion engine 10 according to the first embodiment, an explanation of the components is omitted hereinafter.

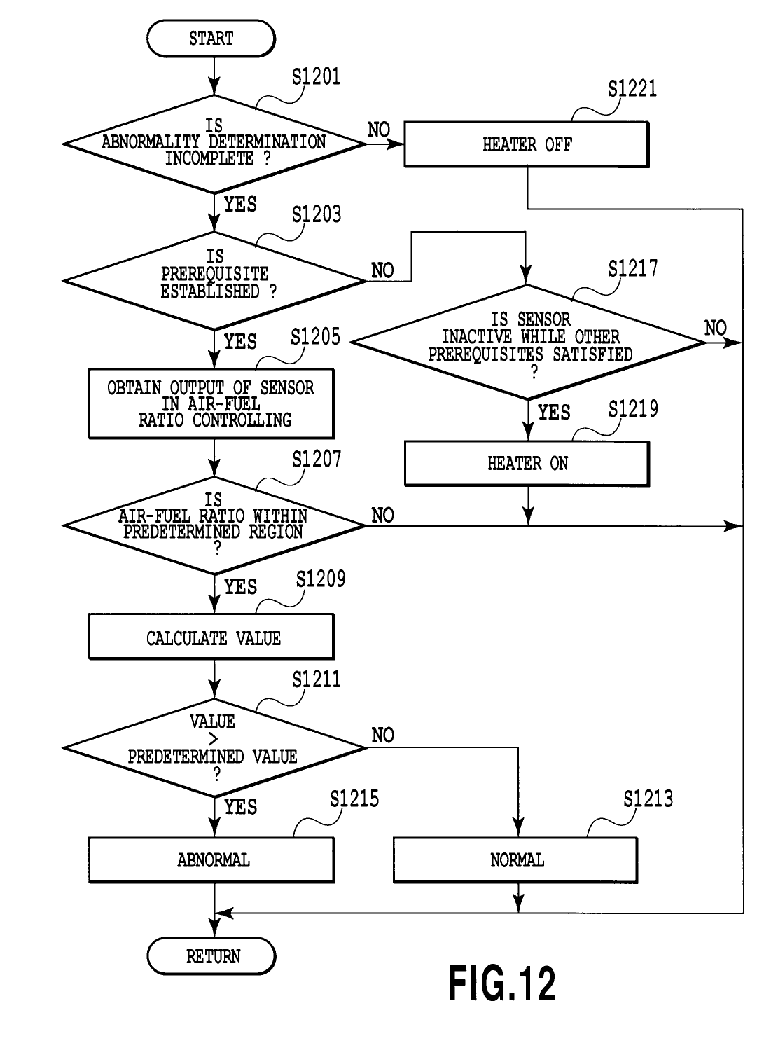

An explanation will be made on detection of variation abnormality in an air-fuel ratio between cylinders according to the fifth embodiment. FIG. 12 shows a routine for detecting the variation abnormality in the air-fuel ratio between the cylinders according to the fifth embodiment. The routine can be repeatedly executed by the ECU 50. However, steps S1201 to S1215 in FIG. 12 respectively correspond to steps S501 to S515. Therefore, hereinafter, steps S1217 to S1221 will be explained.

The third air-fuel ratio sensor 56 as the O₂ sensor is provided for detecting the variation abnormality in the air-fuel ratio between the cylinders. Therefore, an active state of the third air-fuel ratio sensor may be only required to be maintained at the detection time alone, and use of the heater is effective for it. However, when the heater is turned on in a case where an element of the third air-fuel ratio sensor is covered with condensed water in the exhaust gas, a rapid temperature change occurs in the element of the third air-fuel ratio sensor, possibly generating element crack.

Therefore, according to the fifth embodiment, when the prerequisite is not satisfied (negative determination in step S1203) and the prerequisite is not satisfied as a whole since only the condition that the state of the third air-fuel ratio sensor is an active state (active condition 2 or prerequisite 2) is not satisfied particularly among the prerequisites (positive determination in step S1217), the ECU 50 having a function as heating controlling means turns on the heater of the third air-fuel ratio sensor 56 (step S1219). This means that when the third air-fuel ratio sensor is not covered with water since the condition that an engine cooling water temperature is equal to or more than a predetermined temperature (prerequisite 4) is satisfied and the exhaust passage is substantially heated to the predetermined temperature, that is, when the internal combustion engine 10 becomes in a state after the predetermined warming-up, the heater of the third air-fuel ratio sensor 56 is turned on. Therefore, the element crack in the third air-fuel ratio sensor 56 is prevented.

Thereafter, as soon as the determination on the presence/absence of the variation abnormality in the air-fuel ratio between the cylinders (steps S1211 to S1215) is completed (negative determination in step S1201), the heater of the third air-fuel ratio sensor 56 is turned off (step S1221). Thereby heater power supply time can be shortened to enhance an energy saving effect.

It should be noted that such heater control in the fifth embodiment may be incorporated not only in the first embodiment but also in each of the second to fourth embodiments. In consequence, it is possible to more appropriately detect the variation abnormality in the air-fuel ratio between the cylinders.

As described above, the preferred embodiments in the present invention are in detail explained, but the embodiment in the present invention can include the other various embodiments. For example, the internal combustion engine as described above is constructed of an intake port (intake passage) injection type, but the present invention can be applied to a direct injection type engine or a dual injection type engine provided with both of the above injection types. In the above embodiments, the so-called O₂ sensor among the air-fuel ratio sensors is used as the second air-fuel ratio detecting means, but the other sensor may be used. However, it is preferable that the second air-fuel ratio detecting means may be a sensor or a detection device having an output characteristic provided with a region where the output rapidly changes to an air-fuel ratio change. It should be noted that the first air-fuel ratio detecting means may be not the wide-range air-fuel ratio sensor, and may be the other sensor, for example, a so-called O₂ sensor.

The embodiment in the present invention is not limited to the aforementioned embodiments, but the present invention includes all modifications, applications and the equivalents contained in the spirit of the present invention as defined in claims. Therefore, the present invention should not be interpreted in a limited manner and can be applied to any other technologies contained within the scope of the spirit of the present invention.

1. An apparatus for detecting variation abnormality in an air-fuel ratio between cylinders comprising:
first air-fuel ratio detecting means provided in an exhaust passage upstream of an exhaust gas purifying apparatus arranged in the exhaust passage for an internal combustion engine having a plurality of cylinders;
second air-fuel ratio detecting means provided in the exhaust passage upstream of the exhaust gas purifying apparatus and having an output characteristic that an output variation to an air-fuel ratio change in a predetermined air-fuel ratio region is larger as compared to an output characteristic of the first air-fuel ratio detecting means;
air-fuel ratio controlling means for performing air-fuel ratio control for a predetermined period in such a manner as to make an exhaust air-fuel ratio be equal to an air-fuel ratio in the predetermined air-fuel ratio region based upon output from the first air-fuel ratio detecting means; and
abnormality detecting means for detecting variation abnormality in an air-fuel ratio between cylinders based upon output from the second air-fuel ratio detecting means for the predetermined period when the air-fuel ratio control is performed by the air-fuel ratio controlling means.

2. An apparatus for detecting variation abnormality in an air-fuel ratio between cylinders according to claim 1, wherein the first air-fuel ratio detecting means is constructed of a wide-range air-fuel ratio sensor, and the second air-fuel ratio detecting means is constructed of an O₂ sensor.

3. An apparatus for detecting variation abnormality in an air-fuel ratio between cylinders according to claim 1, wherein the predetermined period includes a period for which one cycle is sequentially generated in all of the plurality of the cylinders.

4. An apparatus for detecting variation abnormality in an air-fuel ratio between cylinders according to claim 1, wherein the air-fuel ratio controlling means performs the air-fuel ratio control for the predetermined period in such a manner as to make the exhaust air-fuel ratio be equal to a theoretical air-fuel ratio within the predetermined air-fuel ratio region based upon the output from the first air-fuel ratio detecting means.

5. An apparatus for detecting variation abnormality in an air-fuel ratio between cylinders according to claim 1, wherein the abnormality detecting means includes:
value calculating means for calculating a value reflecting a change of the output from the second air-fuel ratio detecting means for the predetermined period based upon the output; and
determining means for determining that there occurs the variation abnormality in the air-fuel ratio between the cylinders when the value calculated by the value calculating means exceeds a predetermined value.

6. An apparatus for detecting variation abnormality in an air-fuel ratio between cylinders according to claim 1, wherein the air-fuel ratio controlling means performs the air-fuel ratio control in such a manner as to make the exhaust air-fuel ratio be equal to the air-fuel ratio within the predetermined air-fuel ratio region set based upon at least one of a range of an allowance error in an injection quantity by an injector and detection accuracy in the variation abnormality in the air-fuel ratio between the cylinders.

7. An apparatus for detecting variation abnormality in an air-fuel ratio between cylinders according to claim 1, wherein
the air-fuel ratio controlling means repeatedly performs the air-fuel ratio control for the predetermined period in such a manner as to make the exhaust air-fuel ratio be equal to each of a plurality of air-fuel ratios within the predetermined air-fuel ratio region, based upon the output from the first air-fuel ratio sensor, and
the abnormality detecting means includes:
value calculating means for calculating a value reflecting a change of the output from the second air-fuel ratio detecting means for the predetermined period based upon the output from the second air-fuel ratio detecting means for the predetermined period to each of the plurality of the air-fuel ratios when the air-fuel ratio control is performed by the air-fuel ratio controlling means;
maximum value selecting means for selecting a maximum value from the plurality of the values calculated from the value calculating means; and
determining means for determining that there occurs the variation between the cylinders when the value selected by the maximum value selecting means exceeds a predetermined value.

8. An apparatus for detecting variation abnormality in an air-fuel ratio between cylinders according to claim 7, further comprising:
inhibiting means for inhibiting an operation of the determining means when a deviation amount from a reference air-fuel ratio in regard to an air-fuel ratio set as a target in the air-fuel ratio controlling means corresponding to the value selected by the maximum value selecting means exceeds a predetermined deviation amount.

9. An apparatus for detecting variation abnormality in an air-fuel ratio between cylinders according to claim 1, further comprising:
heating means provided in the second air-fuel ratio detecting means;
prerequisite determining means for determining whether or not prerequisites of the operations for the air-fuel ratio controlling means and the abnormality detecting means, which include an active condition that a state of the second air-fuel ratio detecting means is an active state, are satisfied; and
heating controlling means for operating the heating means when it is determined by the prerequisite determining means that the prerequisite is not satisfied since only the active condition among the prerequisites is not established.

10. A method for detecting variation abnormality in an air-fuel ratio between cylinders in an internal combustion engine having a plurality of cylinders, comprising:
a step for performing air-fuel ratio control for a predetermined period in such a manner as to make an exhaust air-fuel ratio be equal to an air-fuel ratio in a predetermined air-fuel ratio region based upon output from first air-fuel ratio detecting means provided in an exhaust passage upstream of an exhaust gas purifying apparatus; and
a step for detecting variation abnormality in an air-fuel ratio between cylinders based upon output from second air-fuel ratio detecting means for the predetermined period when the air-fuel ratio control is performed, the second air-fuel ratio detecting means being provided in the exhaust passage upstream of the exhaust gas purifying apparatus and having an output characteristic that an output variation to an air-fuel ratio change in the predetermined air-fuel ratio region is larger as compared to an output characteristic of the first air-fuel ratio detecting means.

11. A method for detecting variation abnormality in an air-fuel ratio between cylinders according to claim 10, wherein the first air-fuel ratio detecting means is constructed of a wide-range air-fuel ratio sensor, and the second air-fuel ratio detecting means is constructed of an O₂ sensor.

12. A method for detecting variation abnormality in an air-fuel ratio between cylinders according to claim 10, wherein the predetermined period includes a period for which one cycle is sequentially generated in all of the plurality of the cylinders.

13. A method for detecting variation abnormality in an air-fuel ratio between cylinders according to claim 10, wherein the step for detecting the abnormality comprises:
a step for calculating a value reflecting a change of the output from the second air-fuel ratio detecting means for the predetermined period based upon the output; and
a step for determining that there occurs the variation abnormality in the air-fuel ratio between the cylinders when the value calculated by the step for calculating the value exceeds a predetermined value.
